(19) United States
(12) Patent Application Publication
(10) Pub. No.: US 2005/0034076 A1
(43) Pub. Date: Feb. 10, 2005

(54) Combining clips of image data

(75) Inventors: Josee Belhumeur, Montreal (CA); Lyne Van Der Knaap, St. Hubert (CA); Nicolas St. Pierre, Montreal (CA)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk Canada Inc.

(21) Appl. No.: 10/869,160

(22) Filed: Jun. 16, 2004

(30) Foreign Application Priority Data
Jul. 25, 2003 (GB) 03 17 456.2

(51) Int. Cl. G09G 5/00

(52) U.S. Cl. 715/723; 715/724; 715/725; 715/726; 715/732

(57) ABSTRACT

A computer based system (101) combines clips of image frames in which elements from selected input frames are combined to produce an output sequence derived from a plurality of clips. A display unit (105) displays spatially overlaid clips as layers (501,502,503) in a three-dimensional space; User commands specify how elements from a plurality of displayed clips are to be composited spatially to produce compositing data. In addition, temporally displaced clips are displayed as a time-line having clip segments (801, 802, 803) joined by transitions. Attributes of said transitions are modified in response to user generated edit data and a rendering engine (901) renders selected input frame data in combination with said compositing data and said editing data to produce viewable output data.

### CROSS-REFERENCE TO RELATED PATENTS

This application claims the benefit under 35 U.S.C. §119 of the following co-pending and commonly assigned foreign patent application, which application is incorporated by reference herein:

United Kingdom Application No. 03 17 456.2, entitled “COMBINING CLIPS OF IMAGE DATA”, by Josee Belhumeur, Lyne Van der Knaap, and Nicolas St. Pierre, filed on Jul. 25, 2003.

### BACKGROUND OF THE INVENTION

Clips of image data were traditionally generated on cinematographic film and more recently cinematographic film may be scanned on a frame-by-frame basis so as to facilitate subsequent manipulation in the digital domain. Image data frames may exist in several formats, such as interlaced formats in which a frame is made up of two interlaced fields.

It is well known to combine image data frames in a sequential basis in a process usually referred to as editing. Editing operations are effectively a temporal process although it is appreciated that different types of transitions may occur where there is a degree of overlap as the process transforms from one source to another. Typically, these transitions take the form of cuts, wipes or dissolves.

The first type of non-linear editing systems, generally computer based with data being stored on magnetic disk, were off-line systems in that the editing process was performed with respect to a reduced data volume resulting in the production of an edit decision list. Further processing would be required upon the original data in order to perform complex transitions or to generate other types of effect. Effects and transitions of this type would require the implementation of a separate effects generator where material will be derived from one or more sources in a process that later became known as compositing.

More recently, compositing systems have become more complex and this has allowed a very large number of sources to be combined within each individual frame, thereby providing a significant degree of artistic manipulation within the spatial context on a frame-by-frame basis. Thus, it is known to organize complex compositing scenes within a compositing environment whereafter these composited scenes may be combined sequentially in an editing environment.

Known on-line editing systems work with respect to the individual pixels on a frame-by-frame basis. Modern compositing systems work in a computer graphics environment in which many processes may be defined, and represented as a schematic process tree, whereafter a rendering operation is performed so as to perform all of the processes together with respect to the originating source material. Generally, systems of this type are not limited in terms of the number of sources that may be deployed and the number of operations that may be specified within the process tree. However, as complexity increases, rendering time increases although this is in turn off-set by the degree of processing capability provided by the facility. Programs of this type are said to be scalable.

### SUMMARY OF THE INVENTION

According to a first aspect of the present invention, there is provided a method of combining clips of image frames in which elements from selected input frames are combined to produce an output sequence derived from a plurality of clips, comprising the steps of displaying a plurality of spatially overlaid clips as layers in a three dimensional space; responding to user commands that specify how elements from a plurality of said displayed clips are to be composited spatially and storing said user defined compositing data; presenting a plurality of temporally displaced clips as a time line having clip segments joined by transitions; modifying attributes of said presented transitions in response to user generated edit data; and rendering said selected input frame data in combination with said compositing data and said editing data to produce viewable output data.

According to a second aspect of the present invention, there is provided apparatus for combining clips of image frames in which elements from selected input frames are combined to produce an output sequence derived from a plurality of clips, comprising: display means for displaying a plurality of spatially overlaid clips as layers in a three-dimensional space; responding means for responding to user commands that specify how elements from a plurality of displayed clips are to be composited spatially to produce compositing data; presenting means for presenting a plurality of temporally displaced clips as a time-line having clip segments joined by transitions; modifying means for modifying attributes of said presented transitions in response to user generated edit data; and rendering means for rendering said selected input frame data in combination with said compositing data and said editing data to produce viewable output data.

### BRIEF DESCRIPTION OF THE DRAWINGS

The invention will now be described by way of example only with reference to the accompanying Figures, in which:

FIG. 1 shows an environment for processing image data;

FIG. 2 details components of the computer system shown in FIG. 1;

FIG. 3 illustrates operations performed by the system shown in FIG. 2;

FIG. 4 illustrates procedures performed in response to user input, as identified in FIG. 3;

FIG. 5 shows a graphical presentation to a user;

FIG. 6 shows a schematic view;

FIG. 7 shows timelines in a compositing environment;

FIG. 8 shows an editing environment timeline; and

FIG. 9 shows a schematic representation of a rendering operation.

### FIELD OF THE INVENTION

The present invention relates to combining clips of image data frames in which elements of selected input frames are combined to form a viewable output sequence.

### DETAILED DESCRIPTION

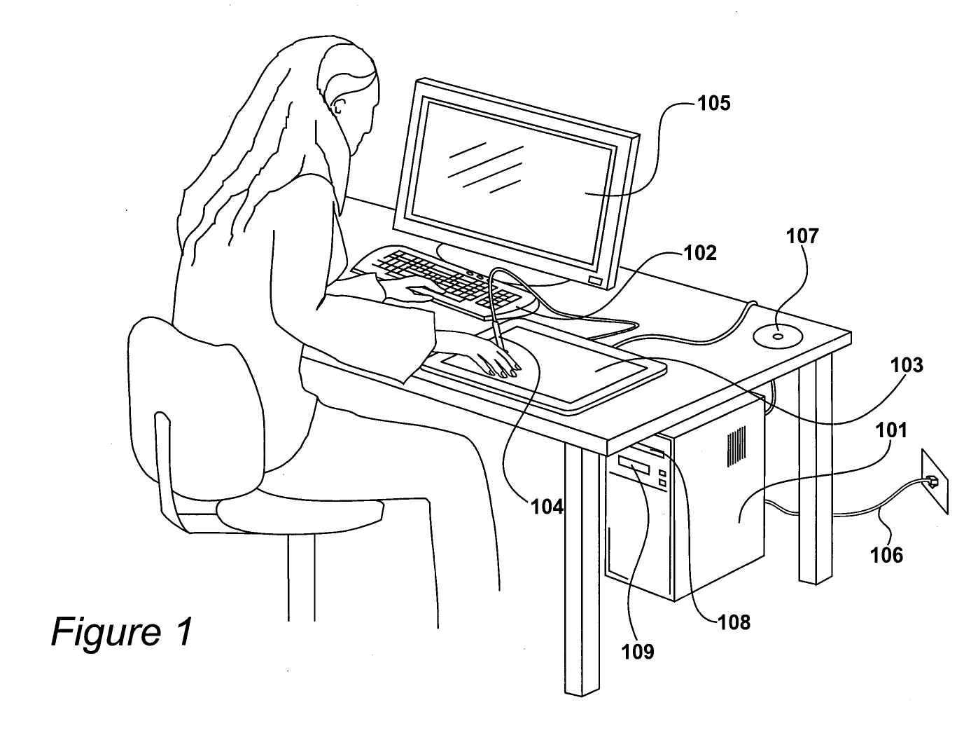

FIG. 1

An image data processing environment is illustrated in FIG. 1. Data processing is effected by a programmable computer system 101 that responds to input data from a user via a keyboard 102, and a touch tablet 103 and stylus 104 combination. Alternatively, other input devices may be used such as a mouse or a tracker-ball. Output data from computer system 101 is displayed to the user via a visual display unit 105. A network connection 106 allows the computer system 101 to communicate with a local server and also facilitates communication externally via the internet.

Computer system 101 receives input data from the keyboard 102 and other input devices via cable connections. Although in alternative embodiments, radio interfaces could be provided. Many different types of programmable computer system 101 could be deployed as an alternative

Instructions executable by computer system 101 are installed via an instruction carrying medium such as a CD-ROM 107 or a similar instruction carrying medium such as a DVD etc. The computer system 101 may also have devices for recording output data, such as CD-ROM burners or DVD burner 108 or removable magnetic disk storage device 109, for example.

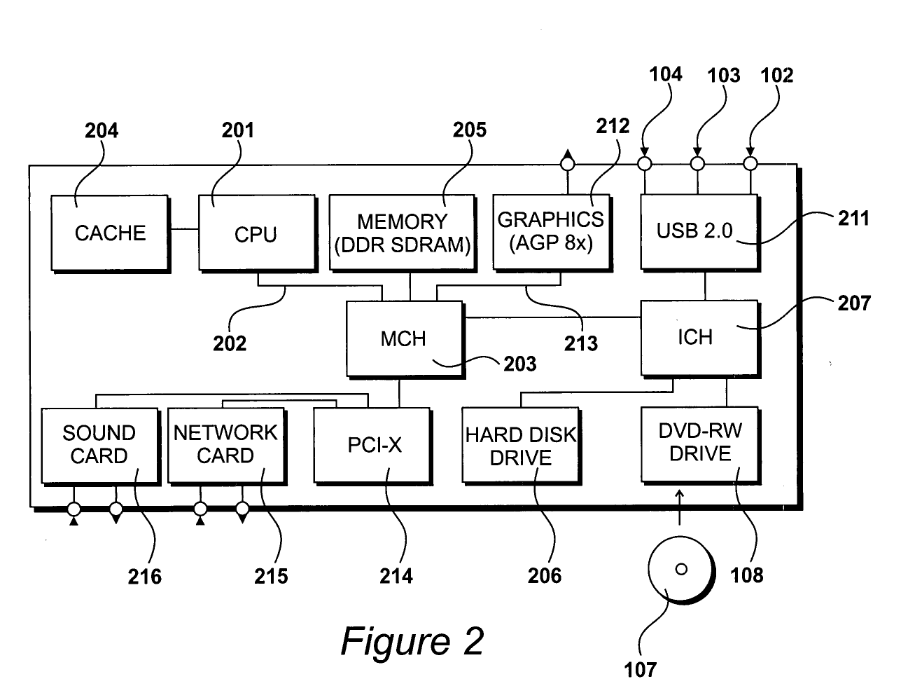

FIG. 2

The components of computer system 101 are detailed in FIG. 2 and, in the preferred embodiment, the components are based upon the Intel® E7505 hub-based Chipset.

The system includes an Intel® Pentium™ Xeon™ DP central processing unit (CPU) 201 running at three Gigahertz (3 GHz), which fetches instructions for execution and manipulates data via an Intel® E7505 533 Megahertz system bus 202 providing connectivity with a Memory Controller Hub (MCH) 203. The CPU 201 has a secondary cache 204 comprising five hundred and twelve kilobytes of high speed static RAM, for storing frequently-accessed instructions and data to reduce fetching operations from a larger main memory 205 via the memory controller hub 203. The memory controller hub 203 thus co-ordinates data and instruction flow with the main memory 205, which is at least one gigabyte in storage capacity, in one or more embodiments. Instructions and data are thus stored in the main memory 205 and the cache 204 for swift access by the CPU 201.

A hard disk drive 206 provides non-volatile bulk storage of instructions and data via an Input/Output Controller Hub (ICH) 207. The controller hub 207 also provides connectivity to storage devices 108 and 109, as shown in FIG. 1. USB 2.0 interface 211 also provides connectivity to manually operable input devices, such as 102,103 and 104.

A graphics card 212 receives graphic data and instructions from the CPU 201. The graphics card 212 is connected to the memory controller hub 203 by means of a high speed AGP graphics bus 213. A PCI interface 214 provides connections to a network card 215 that provides access to the network connection 106, over which instructions and or data may be transferred. A sound card 216 is also connected to the PCI interface 214 and receives sound data or instructions from the CPU 201.

The equipment shown in FIG. 2 constitutes the components of a high-end IBM™ PC compatible processing system. In an alternative embodiment, similar functionality is achieved using an Apple™ PowerPC™ architecture-based processing system.

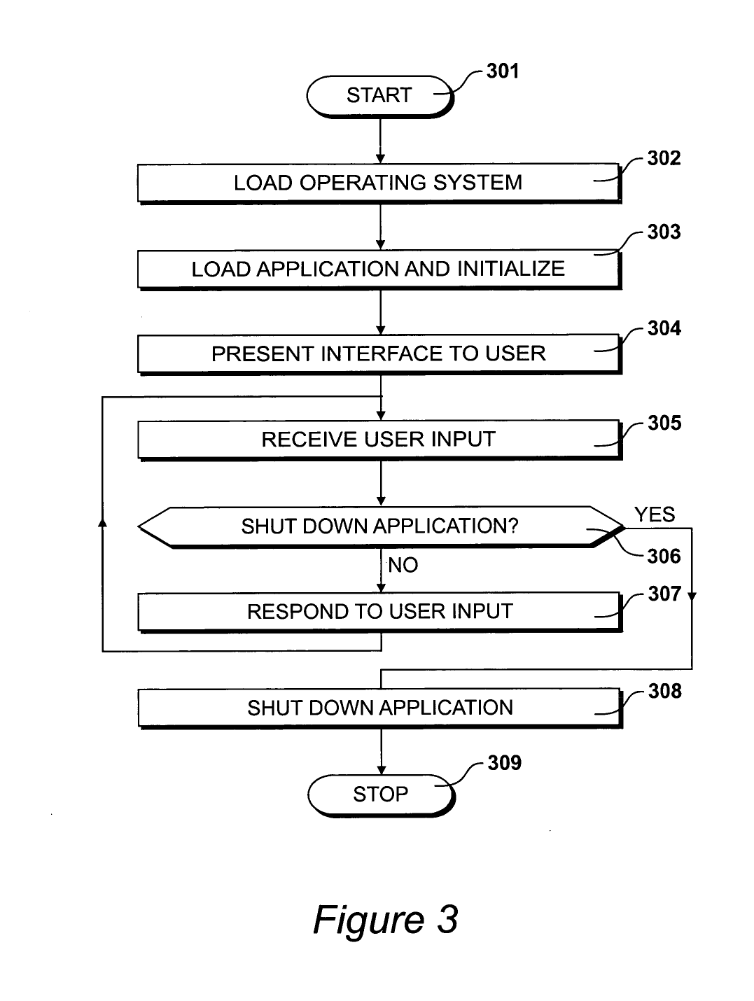

FIG. 3

Operations performed by the system illustrated in FIG. 2 are shown in FIG. 3. After starting operation at step 301, instructions defining an operating system are loaded at step 302. In one or more embodiments, the operating system is Microsoft™ Windows™, but in alternative embodiments, other operating systems may be used such as MacX™ or Linux, for example.

At step 303 instructions for the application of an embodiment are loaded and initialized resulting in a user interface being displayed at step 304.

At step 305 a user input command is received either in response to operation of keyboard 102 or in response to operation of the stylus 104 upon tablet 103.

At step 306 a question is asked as to whether a shutdown command has been received. If this question is answered in the affirmative, the application is shut down at step 308, and the procedure is stopped at step 309. Alternatively, if the question asked at step 306 is answered in the negative, the application responds to the user input (received at step 305) at step 307. Thereafter, further input commands are received at step 305 and further responses are made at step 307 until a shutdown command is received and the question asked at step 306 is answered in the affirmative.

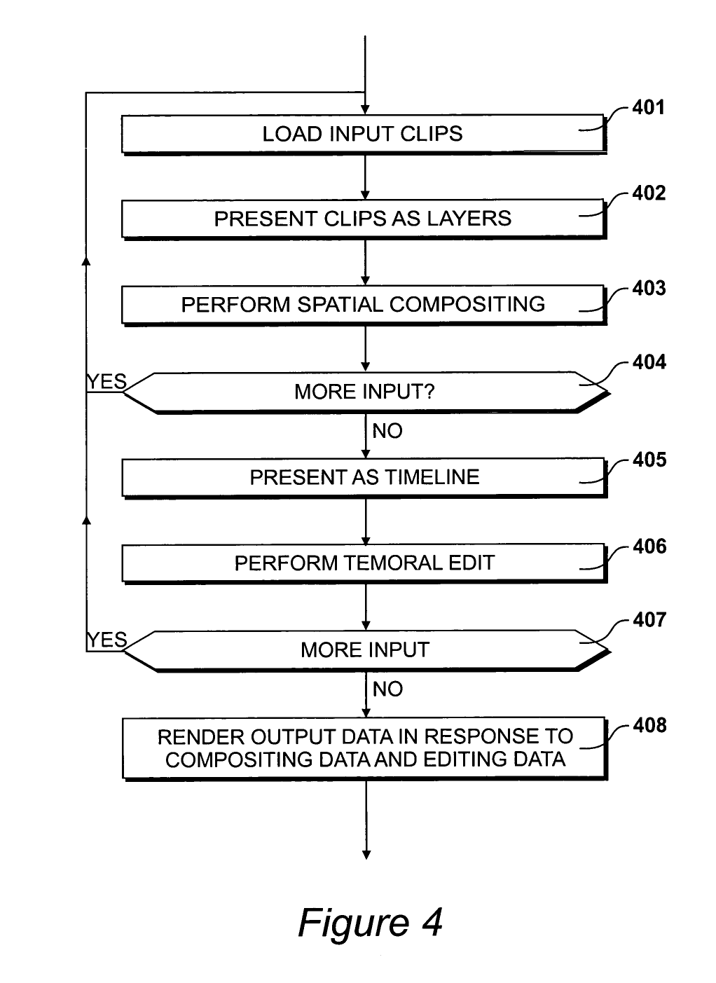

FIG. 4

Procedures identified at step 307 of FIG. 3 are detailed in FIG. 4. At step 401 input clips are loaded, possibly from a video tape recorder, machine-readable data (e.g., disk, tape, etc.), or from a central storage array (framestore) over a network.

At step 402, the clips are presented as layers to facilitate a compositing operation. Thus, at step 403 spatial compositing operations are performed. These may include operations such as chroma-keying, color correction, the introduction of computer generated elements, such as particle streams and the introduction of text and logos etc. Thus, at step 403 the embodiment responds to user commands that specify how elements from a plurality of displayed frames are to be composited spatially resulting in the storage of user defined compositing data.

At step 404 a question is asked as to whether more input is to be considered. When answered in the affirmative, further clips are loaded at step 401. Thus, the compositing operation may result in many clips being brought into the system to create a composite having many individual elements. Composites of this type are generally produced for relatively short sections of output sequences, such as title sequences at the start or at the end of a production, or for individual special effects falling within the body of the production.

Eventually, a point will be reached where a particular section of a production has been completed and further progress may only be made by working in the temporal domain so as to produce output material by a process of editing.

One or more embodiments provide for editing to be performed within the compositing environment. In response to the question asked at step 404 being answered in the negative, an alternative user interface is generated and presented to the user in the form of a timeline at step 405.

At step 406 temporal editing operations are performed by the user in which, in response to being presented with a plurality of temporarily displaced clips on a timeline having clip segments joined by transitions, a user is invited to modify attributes of the presented transitions resulting in the production and storage of user generated edit data.

After performing edits at step 406, a question is asked at step 407 as to whether more input data is required. If this question is answered in the affirmative, further clips are loaded at step 401, and further degrees of compositing and editing may be performed. More material may be loaded but eventually a point is reached at which all of the input material has been considered and the question asked at step 407 is answered in the negative.

At step 408, output data is rendered in response to compositing data and in response to editing data. Thus, in the embodiment, selected input frame data are rendered in combination with the compositing data generated by the user and in combination with the editing data generated by the user to produce viewable output data as an edited sequence of composited frames.

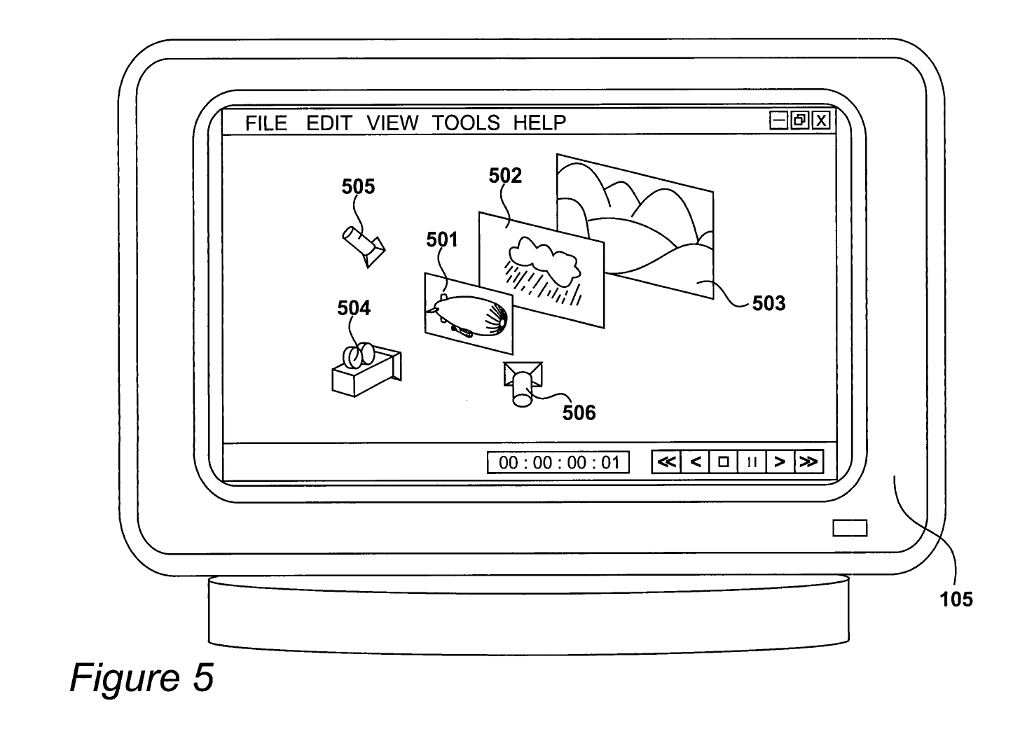

FIG. 5

presentation to a user, on visual display unit 105, as provided by step 402 is illustrated in FIG. 5. In this specific example, shown for illustrative purposes, a first layer 501 is derived from a clip of input material showing a balloon. This clip may have been derived from a model of a balloon shot against a blue or green screen so as to facilitate subsequent chroma-keying. A second clip is represented by a second layer 502 representing weather formations such as clouds, that may have been generated independently on a computer 3D system such as 3DS Max, licensed by the present Assignee. A third clip is represented by a third layer 503 which, in this example, may be considered as a background derived from video footage of a real background scene. Thus, the compositing operation consists of combining footage derived from the balloon model with footage derived from the computer generated weather formation in combination with the real background scene created using conventional techniques.

Within this three-dimensional compositing environment new layers may be introduced and other attributes may be considered within the scene. Thus, a viewport is defined by the provision of a camera icon 504 and in the embodiment several of these camera positions may be derived so as to produce several views of what is essentially the same input data. In addition, light sources, such as sources 505 and 506 may also be specified within the scene so as to change the lighting characteristics of the final composite. Thus, the environment illustrated in FIG. 5 provides users with a significant degree of flexibility and allows many characteristics to be modified so as to enhance the overall realism of the composite. Generally, compositing procedures of this type aim to produce finished results that appear as if real while minimizing the pressure or artifacts that could suggest that the clip has been generated artificially.

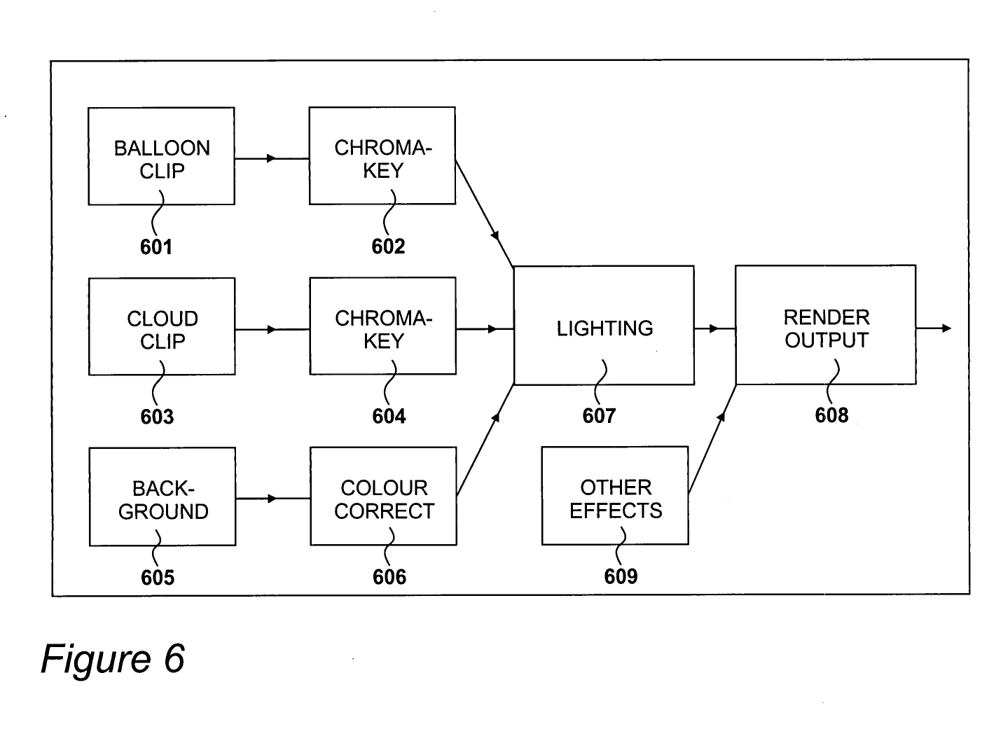

FIG. 6

In addition to displaying the three-dimensional environment of the type shown in FIG. 5, it is also possible to represent the elements as a schematic view as shown in FIG. 6.

The schematic view shows how the rendering operation pulls the material on a pixel-by-pixel and frame-by-frame basis in order to produce sequential output frames that are recorded for subsequent production of viewable data. The ability to render output data in real-time will depend upon the complexity of the scene and the processing available on the platform. However, the complex rendering environment allows many manipulations to be made without the necessity for the whole scene to be rendered. Multiple iterations during the creative process does not result in the generation of large quantities of rendered material. Modifications by the user result in modifications being made to the processes which in turn control the rendering operation when output material is required.

In FIG. 6, the balloon clip, displayed as layer 501, is illustrated as a node 601. A chroma-keying operation is performed against this clip, illustrated by node 602.

The cloud clip, illustrated as layer 502, is shown in FIG. 6 as node 603, and again a chroma-keying operation is performed, illustrated by node 604.

The background clip, illustrated as layer 503, is shown as node 605 and a color correction is performed on this clip, shown as node 606.

The output from nodes 602, 604 and 606 are submitted to a lighting node 607, representing the position of light sources 505 and 506. The rendering operation is illustrated by node 608, to produce an output which also receives other inputs, illustrated generally by node 609 for other effects. Thus, it is possible for a user to view the compositing operation within a schematic view, of the type shown in FIG. 6, whereupon any of the nodes may be selected and parameters modified that are relevant to that particular nodal operation.

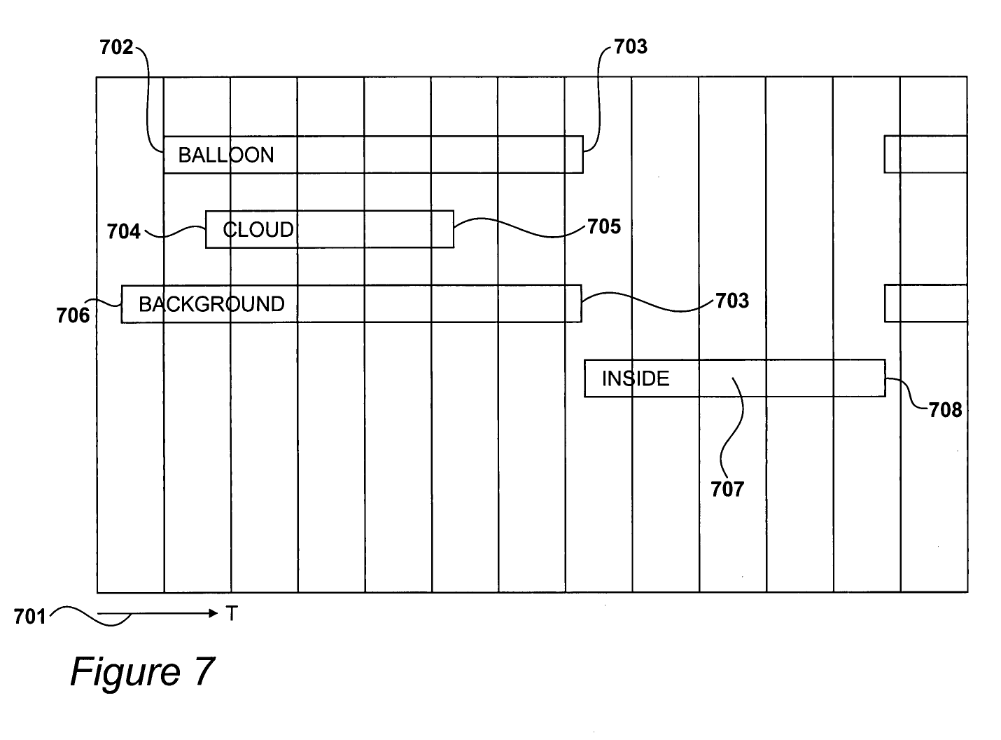

FIG. 7

The traditional compositing environment also allows clips to be shown in a temporal representation, as illustrated in FIG. 7. Time arrow 701 illustrates the passage of time on a frame-by-frame basis such that from time 702 to time 703 the balloon clip is being shown, which in turn, as previously described, is composited with the cloud clip and the background clip. However, the cloud clip is only available from time 704 to time 705, whereas the background clip is available from time 706 to time 703. At time 703, a transition occurs to a different scene representing the inside of the balloon and illustrated in FIG. 7 as an inside clip 707. Thus, the inside clip runs from time 703 to time 708. At time 708 a further transition occurs reverting back to the balloon clip (outside) and the background clip.

Each of the bars illustrated in FIG. 7 may be selected by manual operation of the stylus 104. Thus, it would be possible to reduce the duration of the first scene by effectively moving the cut point to an alternative position in time. However, this would require manual operation so as to modify each individual bar. Furthermore, if the size of a bar is reduced a gap will be introduced resulting in further modification and this in turn could trickle down through the whole scene. Thus, in conventional compositing environments 20 making modifications to what are essentially editing commands can create a significant problem. Thus, generally, compositing is performed within a compositing environment wherein the resulting composites are saved and transferred so as to allow all of the editing to be performed in a separate editing environment.

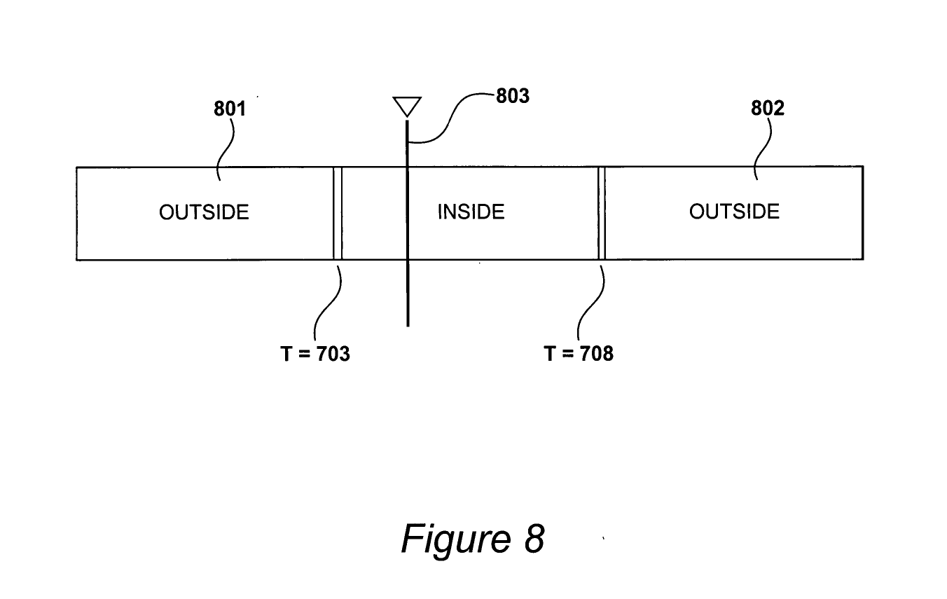

FIG. 8

As described with respect to FIG. 4, after performing spatial compositing operations (i.e., at step 403) the information is presented as a timeline (i.e., at step 405), as illustrated in FIG. 8. In an implementation of the embodiment, effects are achieved by separate modules that plug into a core compositor. Thus, in one or more embodiments, an editing operator has been provided having its own specific set of menus relevant to editing operations. The edit operator has as many inputs as required and the timeline for the edit operator shows the clips in a single edit style, as shown in FIG. 8. Thus, in this representation, the individual clips are not shown one on top of the other, as illustrated in FIG. 7, but are shown in a linear fashion one next to the other, as would be familiar within editing environments.

Within the editing environment of the timeline as shown in FIG. 8, a clip may be removed resulting in the remaining clips adjusting/following by rippling into a new position. Similarly, if a clip is stretched all of the others will move to a new position. The rendering operation may now be performed to produce output in a particular format (e.g., a format preferred by the user) (e.g., an AVI file, etc), or the new edited linear material may be returned to the compositing environment for further compositing operations to be performed.

Thus, the provision of this new operator allows the horizontal nature of the compositing activity to be combined with the temporal preferences of an editing activity. Time is the more relevant parameter within a non-linear editing environment and the embodiment of FIG. 8 provides for this editing process to be performed as a software operator. Thus, the provision of this operator ensures that it is not necessary to re-write the composite style timeline as illustrated in FIG. 7.

It is envisaged that by the provision of this operator, an environment that is essentially constructed for the manipulation of frames in accordance with compositing activities may be extended so as to perform manipulations on substantially longer clips. Thus, the usefulness of the compositing environment is substantially enhanced with users being able to remain within this environment for longer periods of time while making less reliance on external editing systems.

The system provides substantially more flexibility in that it is not necessary to go into and out of different application environments. In one or more embodiments, the activities of the compositor application, including its edit related plug-in, does not result in the material being rendered each time modifications are being made. Furthermore, multiple viewports may be available such that, for example, it would be possible to have two viewports shown on the visual display unit, one derived from a first camera position and the other derived from a second position. Furthermore, for a given platform performance, more sophisticated compositing activities may be defined that will in turn take longer to render. This is because for a given period of time for post-production activities to be completed, less time is wasted in terms of transferring the assets from a compositing environment to an editing environment.

As shown in FIG. 8, layers for the balloon, the cloud, and the background have been combined into a single outside clip, shown at 801 and 802. The system is aware that a transition occurs at time 703 and at time 708. It is now possible for the positions of these transitions to be changed by simply identifying the position of the transitions by means of the touch-tablet 103 and stylus 104 combination, whereafter the positions are dragged while the stylus is maintained in pressure. The transitions are then dropped at the new selected location. These operations are possible on the basis that the original source assets will include “handles” beyond the position of the transition.

In addition, within the editing environment shown in FIG. 8, the nature of a transition may be modified. Thus, for example, a simple cut transition may be changed into a dissolve or a wipe. Furthermore, unlike many non-linear editing environments, it is possible for the wipe or dissolve to be fully implemented within the system given that, by its very nature, all of the capabilities of a fully functional compositing system are readily available and the wipe or dissolve transition becomes part of the overall rendering process.

A section of the material may be displayed and the particular frame being displayed at any instant is represented by a moving cursor 803.

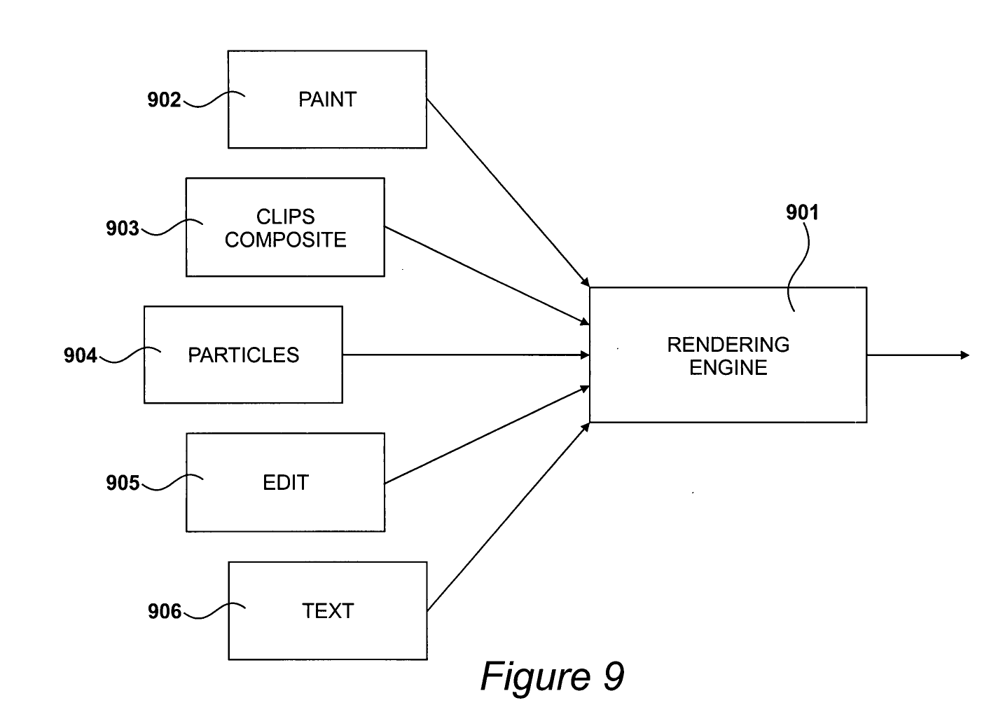

FIG. 9

A schematic representation of the rendering operation is illustrated in FIG. 9. At the heart of the system is a rendering engine 901 which essentially pulls source material on a frame-by-frame basis and performs the rendering operations pixel-by-pixel in response to the definitions provided within each of the individual plug-in components. Examples of plug-in components are shown in FIG. 9, consisting of a paint component 902, a compositing component 903, a particles component 904, an editing component 905 and a text generating component 906. The present embodiment has been described with respect to the clip compositing operations 903 and the editing operations 905. Thus, compositing may be performed within a compositing environment in response to controller 903, with editing operations being provided with an editing controller 905.

As described above, one or more embodiments provide a greater degree of flexibility and overall provides a technical contribution in terms of increasing the speed with which post-production activities may be completed. It may be used in many specific production situations. For example, it is possible to record material for film using a high definition video recorder. Thereafter, it is possible to re-frame the shot within the post-production environment.

In an alternative application, material may be shot using hand-held cameras thereby removing the requirement for providing tripods etc. The very nature of performing production using these techniques, even when employing the best cameramen, introduces a degree of camera shake. However, the inclusion of this shake may be reduced significantly by using stabilizer functions within the compositing environment. Thereafter, separate clips may be combined together through the editing process and an edited sequence may be fed back to the compositing environment to effect the correct color balance etc. Thus, systems of this type allow more to be done in realistic time frames within the post-production environment thereby reducing the burden upon production techniques to record the material under ideal conditions.

1. A computer implemented method of combining clips of image frames in which elements from selected input frames are combined to produce an output sequence derived from a plurality of clips, comprising the steps of:
displaying a plurality of spatially overlaid clips as layers in a three dimensional space;
responding to user commands that specify how elements from a plurality of said displayed clips are to be composited spatially and storing said user defined compositing data;
presenting a plurality of temporally displaced clips as a time line having clip segments joined by transitions;
modifying attributes of said presented transitions in response to user generated edit data; and
rendering said selected input frame data in combination with said compositing data and said editing data to produce viewable output data.

2. The method according to claim 1, wherein said clips are derived from scanning cinematographic film, from video tape or from a machine-readable source.

3. The method according to claim 1, wherein said user commands are received from user operable input devices.

4. The method according to claim 1, wherein selected input frame data, editing tablet and compositing data are rendered in combination with other components defined as software operators.

5. The method according to claim 4, wherein said software operators include chroma-keying processes, paint modules, particle generators or text editors.

6. The method according to claim 1, wherein one or more of said temporally displaced clips presented in the time line comprise a composited clip defined by the user-defined compositing data.

7. The method according to claim 1, wherein the plurality of temporally displaced clips are displayed in a single edit style in a linear fashion.

8. An apparatus for combining clips of image frames in which elements from selected input frames are combined to produce an output sequence derived from a plurality of clips, comprising:
display means for displaying a plurality of spatially overlaid clips as layers in a three-dimensional space;
responding means for responding to user commands that specify how elements from a plurality of displayed clips are to be composited spatially to produce compositing data;
presenting means for presenting a plurality of temporally displaced clips as a time-line having clip segments joined by transitions;
modifying means for modifying attributes of said presented transitions in response to user generated edit data; and
rendering means for rendering said selected input frame data in combination with said compositing data and said editing data to produce viewable output data.

9. The apparatus according to claim 8, further comprising means for deriving said clips using means for scanning cinematographic film, means for playing video tape, or means for reading machine-readable data.

10. The apparatus according to claim 8, further comprising user operable input devices, wherein said user commands are received via said input devices.

11. The apparatus according to claim 8, wherein said rendering means comprises means for rendering selected input frame data and compositing data in combination with other components defined as software operators.

12. The apparatus according to claim 11, wherein said rendering means is configured to operate in response to chroma-keying processes, paint modules, paint generators, or text editors.

13. The apparatus according to claim 8, wherein one or more of said temporally displaced clips presented in the time line comprise a composited clip defined by the user-defined compositing data.

14. The apparatus according to claim 8, wherein the plurality of temporally displaced clips are displayed in a single edit style in a linear fashion.

15. An article of manufacture comprising a program storage medium readable by a computer and embodying one or more instructions executable by the computer to perform a method for combining clips of image frames, the method comprising:
displaying a plurality of spatially overlaid clips as layers in a three-dimensional space;
responding to user input commands that specify how elements from a plurality of said displayed clips are to be composited spatially and storing said user define compositing data;
presenting a plurality of temporally displaced clips as a time-line having clip segments joined by transitions;
modifying attributes of said presented transitions in response to user generated edit data and storing said edit data; and
rendering said selected input frame data in combination with said compositing data and said editing data to produce viewable output data.

16. The article of manufacture according to claim 15, wherein said clips are derived from scanning cinematographic film, from video tape or from a machine-readable source.

17. The article of manufacture according to claim 15, wherein said user commands are received from user operable input devices.

18. The article of manufacture according to claim 15, wherein selected input frame data, editing tablet, and compositing data are rendered in combination with other components defined as software operators.

19. The article of manufacture according to claim 18, wherein said software operators include chroma-keying processes, paint modules, particle generators, or text editors.

20. The article of manufacture according to claim 15, wherein one or more of said temporally displaced clips presented in the time line comprise a composited clip defined by the user-defined compositing data.

21. The article of manufacture according to claim 15, wherein the plurality of temporally displaced clips are displayed in a single edit style in a linear fashion.
